(19) United States
(12) Patent Application Publication
(10) Pub. No.: US 2013/0218888 A1
(43) Pub. Date: Aug. 22, 2013

(54) SYSTEM AND METHOD FOR ASSIGNING TAGS IN A CALENDAR

(71) Applicant: Doree Duncan SELIGMANN, New York, NY (US)

(72) Inventor: Doree Duncan SELIGMANN, New York, NY (US)

(73) Assignee: Avaya Inc., Basking Ridge, NJ (US)

(21) Appl. No.: 13/401,109

(22) Filed: Feb. 21, 2012

(51) Int. Cl. G06F 17/30

(52) U.S. Cl. 707/736; 707/E17.058

(57) ABSTRACT

Disclosed herein are systems, methods, and non-transitory computer-readable storage media for assigning tags in a calendar. These tags can be hashtags, metadata, or other markings used to identify or classify an item. These tags are received and associated with an event, which can be a previous, present, or future event. A calendar is identified based on the tag and the event. In certain instances this identification lends to a work calendar, whereas in other instances the identification lends to a personal calendar, a community calendar, a shared calendar, or a public calendar. Upon identifying the calendar, the tag is inserted into the identified calendar, and associated with a calendar entry in the calendar, the calendar entry being associated with the event.

### BACKGROUND

1. Technical Field

The present disclosure relates to assigning tags in a calendar and more specifically to integrating tags with past, present, and/or future calendar events.

2. Introduction

Calendars play an important role in users' lives. Whether planning future vacations, work meetings, a daily schedule, monthly appointments, or even what television shows to watch, a calendar helps users coordinate activities and remember plans. While traditional paper calendars are produced and purchased each year, the electronic calendar has equaled, if not surpassed, the popularity of the paper calendar. Software and services such as Outlook®, Google Calendar™, and applications which provide calendars for smartphones provide scheduling options which allow for easily adjusting dates, times, invitees, subject matter, and priorities. Software calendars, otherwise known as electronic calendars, also make sharing one's calendar with others a viable option, thereby allowing for coordination of meetings and events.

Because they can be used on computers, computer tablets, smartphones, and other portable computer devices, electronic calendars can be synchronized between devices and servers to provide a single overview of past, present, and upcoming events and reminders. These electronic calendars also allow users the ability to easily search the calendar for particular events or names included in the annotated events. Generally, users manually enter these searchable data fields, such as dates, names, and attendees, though certain calendaring variants can automatically fill in information. As an example, many electronic calendaring programs allow events to re-occur weekly or month, and the computing device will automatically fill in the associated information, either based on a first occasion or based on a pattern of occurrences.

Electronic calendaring can incorporate data from other electronic sources, such as friends' calendars, and can be manipulated by an email client, for example. However, electronic calendars currently do not incorporate or otherwise use tags to enhance calendar data.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The approaches set forth herein can incorporate tags, such as hashtags or other social networking tags, into calendar data. Hashtags first developed on the social media website Twitter®, and have become a quick and efficient way of categorizing items without the use of a structured hierarchy. Hashtags are formed using the “#” symbol plus a single word or phrase, such as “Mucky” or “#Groundhogday”. By incorporating tags into calendar data, an electronic calendar can incorporate such that users can tag, search, and analyze calendars using those tags. The tags set forth herein are primarily described in terms of Twitter hashtags for purposes of illustration, but tags can originate from other sources as well. Example source include a collaborative enterprise tagging system, a social network, and/or communication logs. Tags can include text, alphanumeric characters, emoticons, Unicode characters, images, audio, and other media. Tags can include and/or be associated with metadata. Tag metadata can be included as part of the tag or can be stored separately.

Disclosed are systems, methods, and non-transitory computer-readable storage media for assigning tags in a calendar. These tags can be hashtags, metadata, social network posts, and/or other markings used to identify or classify an item. Users can manually generate tags, or tags can be generated automatically by a machine or computing device. Users can modify automatically generated tags. A system configured according to this disclosure can receive a tag associated with an event, which can be a previous, present, or future event. The system then identifies a calendar based on the tag and the event. For example, a user can explicitly link a tagging account with a particular calendar, or the system can infer a calendar based on information associated with or describing the tag. In certain instances this identification lends to a work calendar, whereas in other instances the identification lends to a personal calendar, a community calendar, a shared calendar, or a public calendar. The system can identify multiple calendars associated with a single user (i.e. a user's personal calendar and work calendar) or associated with multiple users (i.e. separate calendars of a husband and a wife). Upon identifying the calendar, the system then inserts the received tag into the identified calendar, and associates the tag with a calendar entry in the calendar, the calendar entry being associated with the event.

Users can generate the tags, or the system can automatically generate tags based on newspaper headlines, online resources, trending topics, specific times, and other information. For instance, if one were a dedicated fan of a sports team named the Grasshoppers, a system configured according to this disclosure could automatically obtain the calendar for games of the Grasshoppers and enter those games into the user's calendar. The system could then, as the game approaches, automatically place tags associated with each game's calendar entry to state which players are injured or otherwise unavailable for that game, based on online resources or based on user interaction. During the game the system can insert into the game's calendar entry any tags made via social media, such as Twitter®, during the game. Alternatively, the system could detect trending tags by other Grasshopper fans, or the public at large, and insert those into the calendar entry. After the game the system can place a tag indicating a win or a loss, such as “#GrasshopperWin”, “#hatethatcoach”, or “#winningstreak”. An electronic calendar can receive and store tags provides one with another way of organizing, analyzing, and viewing one's past, present, and future plans.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment;

FIG. 2 illustrates an example network configuration;

FIG. 3 illustrates an example of a daily calendar embodiment; and

FIG. 4 illustrates an example method embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

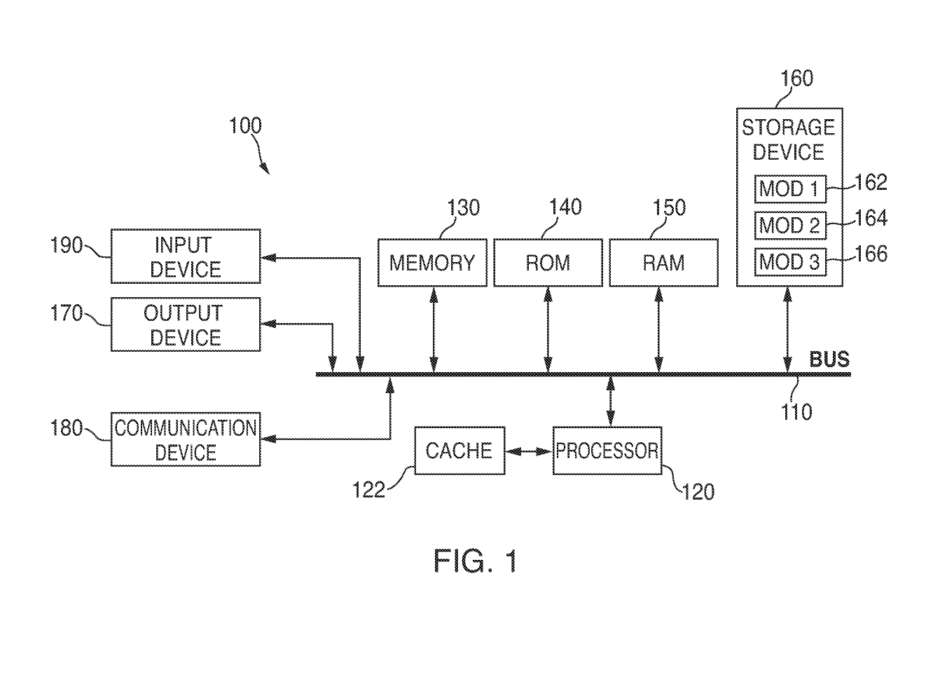

Disclosed herein are approaches for assigning, embedding, and otherwise processing tags in relation with a calendar and/or with calendar events. A system, method and non-transitory computer-readable media are disclosed which receive, and insert, tags into a calendar. A brief introductory description of a basic general purpose system or computing device in FIG. 1 which can be employed to practice the concepts is disclosed herein. A more detailed description of receiving, inserting, and utilizing tags in electronic calendars then follows accompanied by variations. These variations shall be discussed herein as the various embodiments are set forth. The disclosure now turns to FIG. 1.

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache 122 of high speed memory connected directly with, in close proximity to, or integrated as part of the processor 120. The system 100 copies data from the memory 130 and/or the storage device 160 to the cache 122 for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

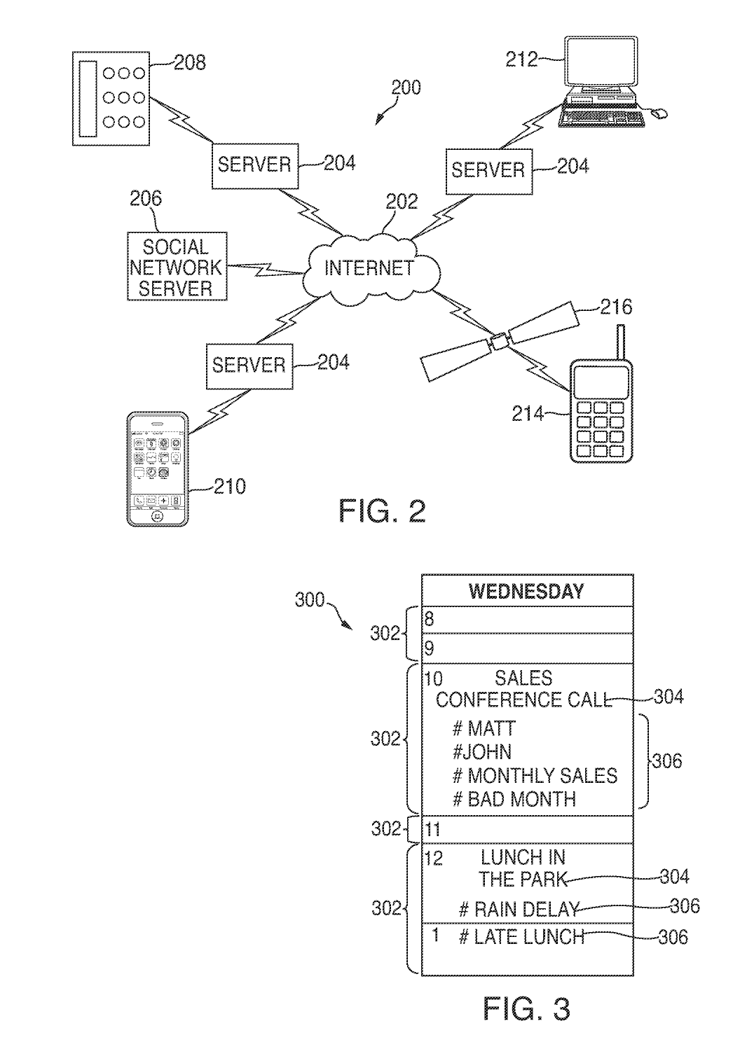

Having disclosed some components of a computing system, the disclosure now turns to FIG. 2, which illustrates an example network configuration 200 used to practice the concepts disclosed herein. Here, various devices such as a telephone 208, a computer 212, a smartphone 210, and a satellite phone 214 connect to the Internet 202 or other suitable network or networks. Other devices, such as tablet computers, automobiles configured with Internet access, and cameras that connect to the Internet are similarly useful. The Internet 202 represents any computer network, and is useful for collaborating information between various users 208, 210, 212, 214 or for any individual user 208, 210, 212, 214 to retrieve information. However, in certain embodiments access to a computer network such as the Internet 202 is unnecessary. In this configuration 200, several users 208, 210, 212 connect to the Internet 202 via a server 204, which can save information, store information, or packetize information.

For example, in the case of the telephone 208, the server 204 can act as a Voice over IP server and convert the analog voice input into a digitized signal prior to communicating the voice over the Internet 202, while acting in reverse for received digital signals. The telephone 208 server 204, can similarly be configured to convert to text the received voice, and record particular phrases as tags, to be later recorded. The computer 212 and smartphone 210 similarly relay information into servers 204, which can store tags, calendars, and other important data. The satellite phone 214 is shown connecting to a satellite 216 acting as a routing server, which in turn places the satellite phone 214 in contact with the Internet 202. By having access to the Internet 202, each of the devices 208, 210, 212, 214 can similarly access a social networking server 206, such as Twitter®, Facebook®, or Google+™. Thus each user 208, 210, 212, 214 can obtain and communicate tags uploaded to the social networking server 206.

Consider the example of Pete, who works in sales and is a fan of the sports team The Grasshoppers. In one example configuration, a server 204 connects to both the Internet 202 and a smartphone 210. Pete, the user of the smartphone 210 uses the calendar built into the smartphone 210 for personal reminders, and Outlook® on a computer 212 at work for work events, with Outlook® configured to sync works events with the smartphone 210 calendar. Pete also has a Twitter® account, where his tweets and tags posted are stored on a social network server 206. These data sources are only examples. The principles set forth herein can also incorporate data from other local and/or network-based sources.

Pete has a work meeting scheduled for 3 PM every second Tuesday of the month concerning sales numbers. Pete can configure a computing device, such as his computer at work, his smartphone, or a separate server, to act as a system configured according to methods and concepts disclosed herein. Prior to Pete's monthly sales meeting, the system can perform a search for tags made by Pete previously about the meeting. For example, perhaps every month Pete tags “#monthlysales” to the calendar entry corresponding to the meeting. The system, seeing this pattern, can automatically place the tag “#monthlysales” in upcoming events. As another aspect of this, users such as Pete can configure the system so that pre-filling future events ties to a threshold, which in turn relies on the types of calendar events and a time-to-fill. For example, perhaps Pete wants to fill all sales meeting in the next 3 months with tags, but wants to fill all birthdays for the next 12 months.

The system can also associate tags with calendar entries for events which have occurred in the past. If, for example, Pete had a Grasshoppers game in his personal calendar, the system could determine the score, either from a database, news articles, or other resources, and retroactively place a tag in the Grasshopper calendar event. This tag could read “#win” or “Moss”. It could also provide player/coaching updates, such as “#georgehurt”, “#ditkafired” or streak updates, such as “#3winstreak”. Similarly, the system can identify significant events, phrases, or other data from news reports, blogs, social network exchanges, emails, etc., and incorporate those events, phrases, or other data as tags into the calendar.

During the event, the system can retrieve tags made by Pete and associate them with the event. The system can also perform an analysis to determine if tweets or other social media contain tags relevant to the current event. Consider if Pete is at a Grasshoppers game and, immediately after the other team scores, Pete tweets “I can't believe they made that goal. #fail”. The system can retrieve that goal, compare Pete's currently scheduled events (the Grasshopper game), the location of the event (an arena), associate the fact that Pete is at an arena with the word “goal” in his tweet, and assume that the tag “#fail” is associated with that calendar event. If the tweet instead read “I can't believe John Candy's been dead for so long. #imissJohn” during the Grasshopper game, the system analysis can determine that the hashtag “#imissJohn” does not apply to the game. When the system is configured using a smartphone, the system can confirm location using GPS, geolocation, triangulation applications, or other positioning or location detection approaches.

The system can be configured to only accept tags created by a user, such as Pete, or the system can be configured to accept tags from other sources. For instance, during Pete's monthly sales meeting the calendar event has two other invitees, Matt and John. As above, the system can place tags corresponding to these individuals in the calendar event, such as “#matt” and “#john”. However, the system can also add any tags created by Matt and John associated with the calendar entry in Pete's calendar. Thus if Matt tags the event with “#bestmonthyet” the system can copy that tag and place it in the calendar entry of Pete's calendar. In another configuration, the system can obtain tags from other people who may not be directly associated with an event. For example, if Pete is at the Grasshoppers game and 10,000 people tweet “GOAL! #goal #gograsshoppers” within a minute of one another, the system can recognize the tags, and selectively place a #goal tag in the event. Depending on the calendar the tag is being inserted into, the system can also place the #goal at a specific time within the event. This configuration allows the user to look back and see tags in a timeline.

Continuing with the sports example, Pete can later perform a search for tags with “goal”, and notice that on a specific date there were three tags placed associated with an event. The system can further correlate these with a news source or database, such that the tags are associated with the specific times in the game. Thus Pete can see that the Grasshoppers scored three goals, one at the 5^{th} minute of the first half, one at the 10^{th} minute of the second half, and one in the 3^{rd} minute of overtime. In yet another configuration, the calendar of a user is only updated by a pre-selected group or people directly associated with the calendar entry. In this configuration, the fact that 10,000 people at the game tweeted nearly simultaneously does not affect the tags of Pete's calendar. However, if Pete had created a calendar entry stating that Matt and John were also coming to the Grasshopper's game, then the system can copy tags from Matt and John into Pete's calendar. In yet another example of this, if Pete follows an individual on Twitter® and that individual creates a tag deemed sufficiently relevant to a calendar event of Pete, the system can copy that tag into Pete's calendar entry.

Yet other system configurations allow a user's calendar to update tags based on individual news sources, news aggregators, or on trending topics. In one example, Pete can configure his system to annotate his calendar everyday with the top 5 trending Twitter® tags of the previous day. Pete can then review and study those topics. In another example, Pete's system is configured to grab the top topics from online news sources such as the New York Times®, The Wall Street Journal®, or Yahoo.com. Should Pete desire, he can utilize a news aggregator, which analyzes many online databases and resources to determine top headlines over a given period. Tags associated with those top headlines are then inserted into the calendar for review on the current day or as a record of previous headlines.

Tags allows for an additional means of searching calendar events. For example, if Pete searches his calendar and desires to know when the Grasshoppers had won, Pete can perform a query of tags such as “#win”, and the system returns corresponding entries. Tag searching can also utilize additional fields for both tags and calendar entries. As an example, Pete can search for both “#grasshoppers” and “#win” to distinguish that he is only interested in Grasshopper wins, or Pete can search for calendar entries in September that have a tag of “#win”.

In another aspect, the system distinguishes between personal and work calendars. For example, Pete only allows tags from his Twitter® feed to be placed into his personal calendar, while in another configuration Pete allows his Twitter® tags to be placed into his work calendar. The system can filter tags into the correct calendar based on events scheduled in each calendar or based on user preferences. These preferences can be user defined, or determined by the system using a behavior analysis.

FIG. 3 illustrates an example of a daily calendar embodiment 300. This example, showing a single day 300, has various time slots 302 for recording events or meetings. In two of these time slots, at 10 and at 12, the user has two calendar entries 304 corresponding to real world events. Associated with the calendar entries are several tags 306. In the first calendar entry, the “Sales Conference Call” 304, the tags 306 read “#Matt”, “#John”, “#Monthly Sales”, and “#Bad Month”. These tags, entered before, during, or after the Sales Conference Call, are quick reminders of items associated with the event corresponding to the calendar entry.

While hashtags, such as “#win” and “#grasshoppers” have been used as throughout this description, other forms of tags are equally viable without the constraints hashtags impose. For example, whereas hashtags normally require a pound symbol (#), and a single entry without spacing, the disclosed systems make no such restrictions. Systems configurations can use only hashtags, or systems can use non-hash text, URLs, contacts, pictures, or any combination thereof.

In the second calendar entry 304 shown in FIG. 3, “Lunch in the Park”, a first tag indicates a rain delay (“#raindelay”). A second tag shortly thereafter states a late lunch was taken (“#latelunch”). In situations such as this, the tags were placed by a user into the calendar, or created and entered by the system, during or after the times corresponding to the tags. However, in the case of the “#latelunch” tag, there is no corresponding event. In such instances the system can extend calendar event times, move a calendar event, copy a calendar event, or create a new calendar event. In other configurations, a calendar can be configured to accept tags without associated events. While this example demonstrates displaying tags in connection with calendar events, the system can associate or index tags with calendar events in a database to enable calendar searchability by tag. In this case, even though the calendar incorporates tags, the calendar may not display the tags. The calendar can alternatively display only a top tag associated with a calendar event, or can display only those tags having some value that exceeds a particular threshold. For example, the calendar can display tags that more than 50% of Pete's social network friends have accepted or approved.

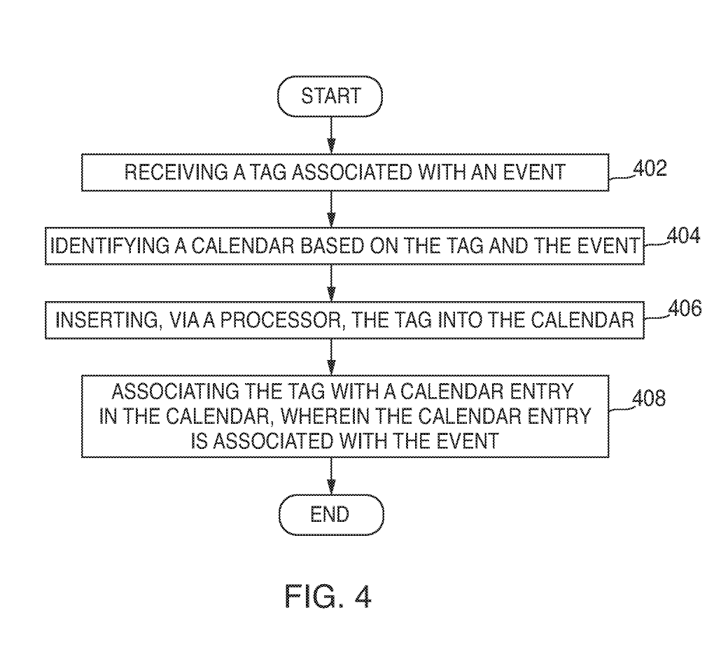

Having disclosed some basic system components and concepts, the disclosure now turns to the exemplary method embodiment shown in FIG. 4. For the sake of clarity, the method is discussed in terms of an exemplary system 100 as shown in FIG. 1 configured to practice the method. The steps outlined herein are exemplary and can be implemented in any combination thereof, including combinations that exclude, add, or modify certain steps.

A system 100 receives a tag associated with an event (402). This tag can be a hash tag, a text, a URL, a contact, a picture, or a combination thereof. This tag can be received from a social media server such as Twitter®. The system can actively search for tags, such as via a web crawler or other automated process that discovers and analyzes tags, or the system can receive tags that some other human or automated entity identifies and/or prepares. The system then identifies a calendar based on the tag and the event (404) and inserts the tag into the calendar (406). The system can insert the tag into the calendar directly, into a calendar event, edit a calendar event to incorporate the tag, edit metadata associated with a calendar event, or insert the tag into a database referenced by or associated with the calendar without actually modifying the calendar itself The system 100 then associates the tag with a calendar entry in the calendar, wherein the calendar entry is associated with the event. The tag received can be created by a user associated with the calendar identified, or can be created by an individual not associated with the calendar identified. The system 100 can further analyze a set of tags to determine the tag, where the set of tags is received from an online resource listing patterns, or trends, of tags. In addition, the calendar identified can be one of a set of calendars associated with a user.

The system can process tags in a real-time or substantially real-time fashion, such that the system ingests tags as the system receives tags. Alternatively, the system can process tags in batches, such as after each calendar event or on an hourly or daily basis. When the system searches for likely calendar event matches for a particular tag, the system can apply a tiered approach to analyzing relevant calendar events. For example, if a tag is generated at 3:30 pm on a Tuesday afternoon, the system can perform a complex or detailed analysis of calendar events between 2:00 pm and 5:00 pm on Tuesday, and an intermediate complexity analysis of calendar events on Monday to Wednesday, and a low complexity, faster analysis of remaining calendar events.

In addition, specific circumstances associated with the formation of the tag can lead to variations in future calendar displays. For example, a user can select to see only those tags created prior to the corresponding event times, only those created at the event time, only those created after the event time, or any combination thereof. When conducting searches for tags, the calendar can be arranged to only display tags and dates corresponding to search results, or can highlight or otherwise emphasize search result dates and tags. Depending on the display format desired by the user, this can often require aggregation of various tags. In a daily display, it may be possible to view each tag in a format which shows the exact time assigned a tag. However, in weekly, monthly, or other alternative views, it may be required to aggregate the tags or otherwise indicate that additional tags or tag details are available for display.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein equally to tags received from social media as to tags created by a user and not shared with other individuals. Those skilled in the art will readily recognize various modifications and changes that may be made to the principles described herein without following the example embodiments and applications illustrated and described herein, and without departing from the spirit and scope of the disclosure.

1. A method comprising:
receiving, at a time and from a first user, a social media tag associated with an event;
identifying a calendar of a second user, who is a social media connection of the first user, based on the social media tag and the event;
inserting, via a processor, the social media tag into the calendar; and
associating the social media tag with a calendar entry in the calendar, wherein the calendar entry is associated with the event and created prior to the time.

2. The method of claim 1, wherein the social media tag comprises a hashtag.

3. The method of claim 1, wherein the social media tag comprises at least one of a text, a URL, a contact, and a picture.

4. The method of claim 1, further comprising analyzing a plurality of tags to determine the social media tag.

5. The method of claim 4, wherein the plurality of tags are received from an online resource which lists at least one of a pattern of tags and a trend of tags.

6. The method of claim 1, wherein the social media tag is received from a social media server.

7. The method of claim 6, wherein the social media server is a microblog social media server.

8. The method of claim 1, wherein the social media tag is created by a user associated with the calendar.

9. The method of claim 1, wherein the social media tag is created by an individual not associated with the calendar.

10. The method of claim 1, wherein the calendar is one of a plurality of calendars associated with a user.

11. A system comprising:
a processor; and
a computer-readable storage device storing instructions which, when executed by the processor, cause the processor to perform operations comprising:
receiving, at a time and from a first user, a social media tag associated with an event;
identifying a calendar of a second user, who is a social media connection of the first user, based on the social media tag and the event;
inserting the social media tag into the calendar; and
associating the social media tag with a calendar entry in the calendar, wherein the calendar entry is associated with the event and created prior to the time.

12. The system of claim 11, wherein the social media tag comprises a hashtag.

13. The system of claim 11, wherein the social media tag comprises at least one of a text, a URL, a contact, and a picture.

14. The system of claim 11, wherein the computer-readable storage device stores further instructions which, when executed by the processor, cause the processor to perform a further operation comprising analyzing a plurality of tags to determine the social media tag.

15. The system of claim 14, wherein the plurality of tags are received from an online resource which lists at least one of a pattern of tags and a trend of tags.

16. A computer-readable storage device storing instructions which, when executed by a processor, cause the processor to perform operations comprising:
receiving, at a time and from a first user, a social media tag associated with an event;
identifying a calendar of a second user, who is a social media connection of the first user, based on the social media tag and the event;
inserting the social media tag into the calendar; and
associating the social media tag with a calendar entry in the calendar, wherein the calendar entry is associated with the event, and created prior to the time.

17. The computer-readable storage device of claim 16, wherein the social media tag is received from a social media server.

18. The computer-readable storage device of claim 17, wherein the social media server is a microblog social media server.

19. The computer-readable storage device of claim 16, wherein the social media tag is created by a user associated with the calendar.

20. The computer-readable storage device of claim 16, wherein the social media tag is created by an individual not associated with the calendar.
